(19) United States
(12) Patent Application Publication
(10) Pub. No.: US 2024/0148192 A1
(43) Pub. Date: May 9, 2024

(54) Rib Paddle

(71) Applicant: Joffre Disabatino, Memphis, TN (US)

(72) Inventor: Joffre Disabatino, Memphis, TN (US)

(21) Appl. No.: 16/882,574

(22) Filed: May 25, 2020

(51) Int. Cl. A47J 43/28

(52) U.S. Cl. CPC A47J 43/288

(57) ABSTRACT

Cooking certain types of foods on a grill or smoker, such as baby back or St. Louis ribs often results in breakage of the rib rack or damage to the bark. The most common method of using a spatula presents these issues when turning or removing the rack from the surface of the grill. This invention eliminates these issues.

With cooking utensils such as a spatula, removal often damages the bark or crust that forms on the smoked meat. The surface area of the invention is sufficient to lift and transport a rack of ribs, and its beveled front edge enables the paddle to slide under the rack of ribs without collapsing or damaging the ribs or damaging the bark.

### BACKGROUND OF THE INVENTION

Despite the advancement in the popularity of grilled food, cooking utensils currently used for grilling have remained primitive and suffer from several drawbacks. The most common utensil used for grilling is the conventional spatula. However, turning, in particular, baby back or St. Louis ribs using a spatula is difficult, as the spatula must be slid between the grill surface and the rack of ribs. Often, the user may have difficulty cleanly picking up the rack from the surface of the grill without damaging the rack itself or destroying the delicate bark that forms on the rack during smoking. This way, cooking delicate racks of ribs using a spatula can deteriorate the integrity and appearance of the food.

### BACKGROUND ART

Several patents have been granted for comparable cooking utensils. However, such patents have not addressed the issue of handling delicate baby back or St. Louis ribs without damaging the ribs or the bark. Kohn U.S. Pat. No. 3,411,723A is directed to a disposable spatula. Allen U.S. Pat. No. 2,489,606 is directed to a conventional spatula. Floyd U.S. Pat. No. 9,254,065B2 is directed to a “Wonder Spatula” device, which acts as a pair of tongs with features of a spatula. DiPaolo US Patent 2006/0200995A1 is directed to a multi-purpose cooking utensil with a flat spatula member.

Accordingly, there is a need for a cooking utensil that is simple and easy to use while barbecuing racks of ribs which, like a spatula, can slide under the rack to lift it, but do so without damaging the rack itself or the delicate bark that forms on the smoked meat.

### SUMMARY OF THE INVENTION

The present invention relates to a barbecue or smoker grill paddle which is intended to cleanly peel off racks of ribs from the gill surface without collapse or breakage.

### INVENTION DESCRIPTION

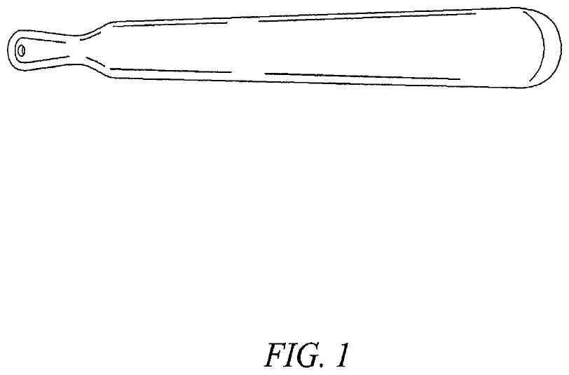

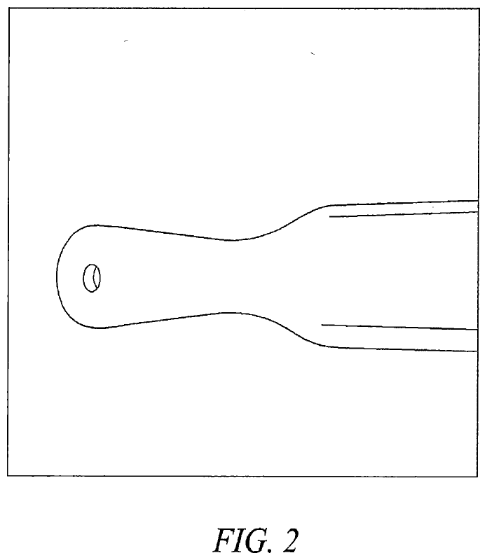

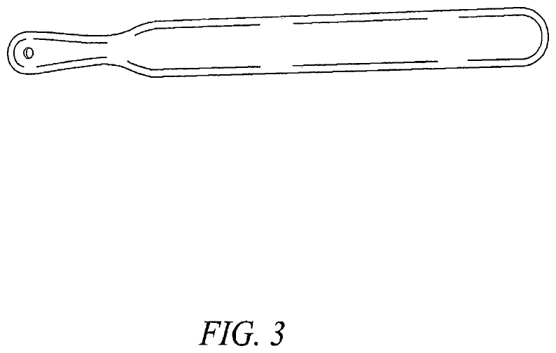

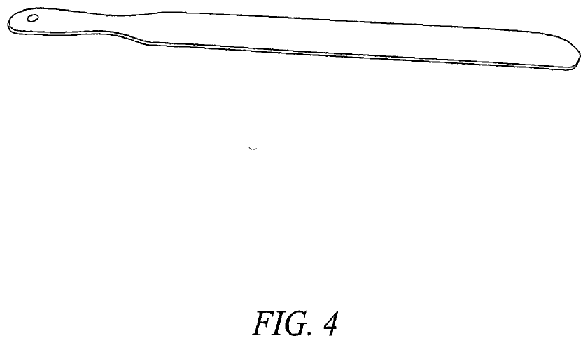

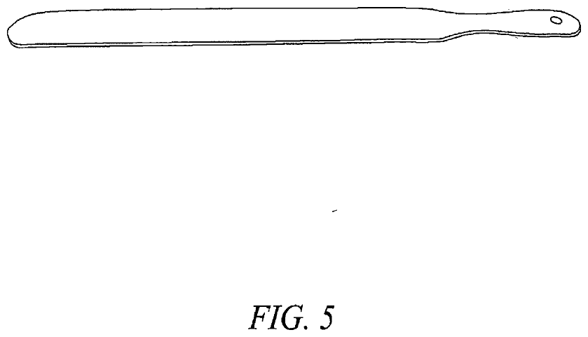

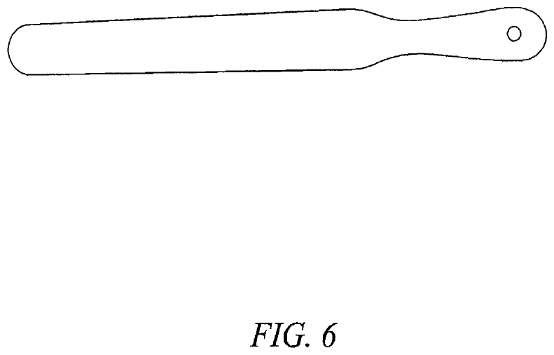

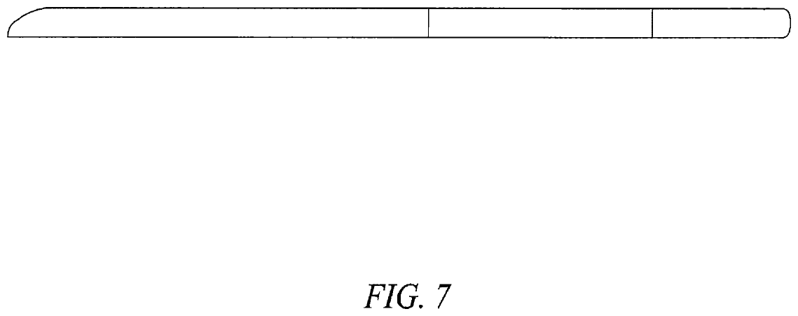

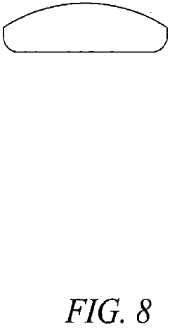

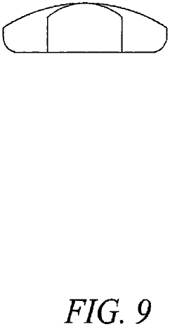

The present invention is a barbecue cooking utensil comprised of one solid piece, the preferred embodiment of which is made of wood, comprising a handle (FIG. 2), a flat surface for loading and handling racks of ribs (FIG. 3), and a beveled front edge (FIG. 7,8,9), which enables the utensil to slide easily under even the most delicate of baby back ribs, without damaging the bark or breaking the ribs, to load, remove or transport a rack of ribs.

Although the present invention has, been described in terms of the preferred embodiments above, numerous modifications and/or additions to the above-described preferred embodiment would be readily apparent to one skilled in the art. It is intended that the scope of the present invention extend to all such modifications and/or additions and that the scope of the present invention is limited solely by the claims of the invention.

1. A cooking utensil comprising a continuous slab of material with an elongated body and a flat surface, having a handle end and an opposite end with a beveled edge.

2. The cooking utensil described in claim 1, wherein the means of sliding underneath the meat without damaging it is achieved by the beveled edge separating the meat from the cooking surface.

3. The cooking utensil described in claim 1, wherein the means of lifting the meat from the cooking surface is accomplished with the elongated flat surface.

4. The cooking utensil described in claim 1, wherein the means of transporting the meat to and from the cooking surface is accomplished with the elongated flat surface.
